(19) United States
(12) Patent Application Publication
(10) Pub. No.: US 2026/0031581 A1
(43) Pub. Date: Jan. 29, 2026

(54) ILLUMINATED ELECTRICAL OUTLET COVER DEVICE

(71) Applicant: Billie Batey, Indianapolis, IN (US)

(72) Inventor: Billie Batey, Indianapolis, IN (US)

(21) Appl. No.: 18/781,179

(22) Filed: Jul. 23, 2024

(51) Int. Cl. H01R 13/717; H01R 13/447

(52) U.S. Cl. CPC H01R 13/7175; H01R 13/447

(57) ABSTRACT

An illuminated electrical outlet cover device includes a wall plate that can be positioned over an electrical outlet in a wall thereby inhibiting children from accessing the electrical outlet. A plurality of electrical contacts is each coupled to the wall plate which are electrically mated to the electrical outlet when the wall plate is positioned over the electrical outlet. A plurality of light emitters is each attached to the wall plate to emit light outwardly from the wall plate when the plurality of light emitters is turned on thereby illuminating a room in which the electrical outlet is positioned. A removal tool is insertable behind the wall plate thereby enabling the removal tool to urge the wall plate into an angled orientation to enable a user to remove the wall plate from the electrical outlet.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to electrical outlet cover devices and more particularly pertains to a new electrical outlet cover device for illuminating a room while covering an electrical outlet to inhibit children from accessing the electrical outlet. The device includes a wall plate that is positionable over an electrical outlet and a plurality of electrical contacts that are each plugged into the electrical outlet when the wall plate is positioned over the electrical outlet. The device includes a plurality of light emitters which are attached to the wall plate for illuminating a room in which the electrical outlet is positioned. The device includes a plurality of color controls for selecting a color of light emitted by the light emitters and a power control for actuating or de-actuating the light emitters.

### (2) Description of Related Art Including Information Disclosed Under 37 CFR 1.97 and 1.98

The prior art relates to electrical outlet cover devices including a light emitting device that includes a series of light emitters integrated into a wall plate and a variety of light emitting wall plate devices that each at least includes a wall plate with a pair of openings to expose sockets of an electrical outlet over which the wall plate is positioned and a plurality of light emitters integrated into the wall plate and an outlet and nightlight device that includes a wall plate with a plurality of electrical contacts that are electrically matable to an electrical outlet over which the wall plate is positioned and a pair female electrical outlets integrated into the wall plate and a light emitter that is movably attached to the wall plate. In no instance does the prior art disclose an illuminated wall plate device that includes a wall plate and a plurality of electrical contacts which are electrically matable to an electrical outlet over which the wall plate is positioned and a plurality of light emitters attached to the wall plate for emitting light and a removal tool that is employed for dislodging the wall plate from the electrical outlet.

### BRIEF SUMMARY OF THE INVENTION

An embodiment of the disclosure meets the needs presented above by generally comprising a wall plate that can be positioned over an electrical outlet in a wall thereby inhibiting children from accessing the electrical outlet. A plurality of electrical contacts is each coupled to the wall plate which are electrically mated to the electrical outlet when the wall plate is positioned over the electrical outlet. A plurality of light emitters is each attached to the wall plate to emit light outwardly from the wall plate when the plurality of light emitters is turned on thereby illuminating a room in which the electrical outlet is positioned. A removal tool is insertable behind the wall plate thereby enabling the removal tool to urge the wall plate into an angled orientation to enable a user to remove the wall plate from the electrical outlet.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of an illuminated electrical outlet cover device according to an embodiment of the disclosure.

FIG. 2 is a back perspective view of an embodiment of the disclosure.

FIG. 3 is an exploded perspective view of an embodiment of the disclosure.

FIG. 4 is a front in-use view of an embodiment of the disclosure.

FIG. 5 is a perspective in-use view of an embodiment of the disclosure showing a removal tool being employed to dislodge a wall plate from an electrical outlet.

FIG. 6 is a schematic view of an embodiment of the disclosure.

### DETAILED DESCRIPTION OF THE INVENTION

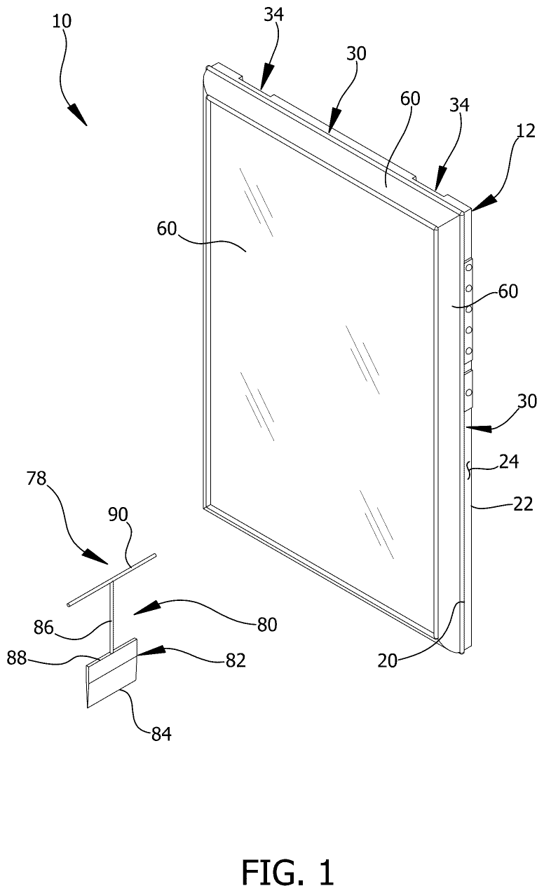

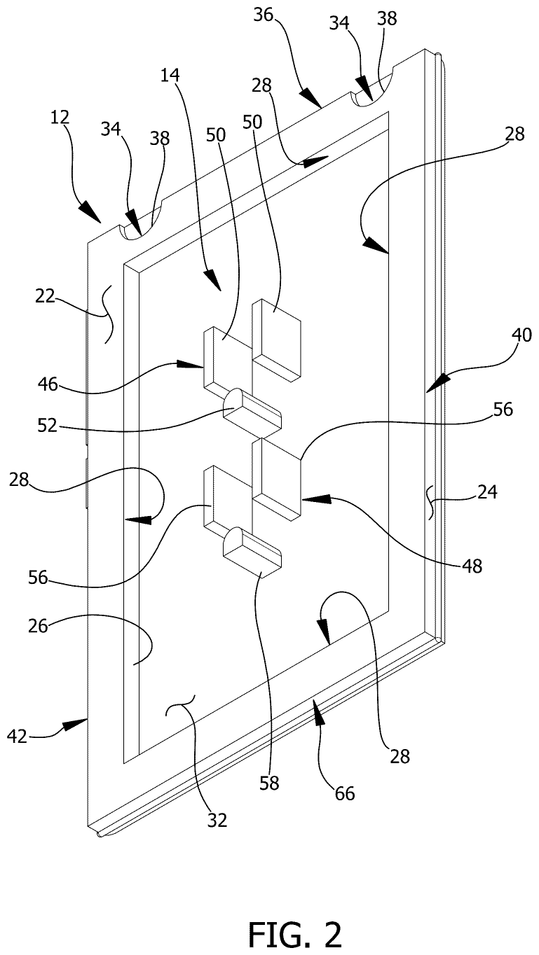

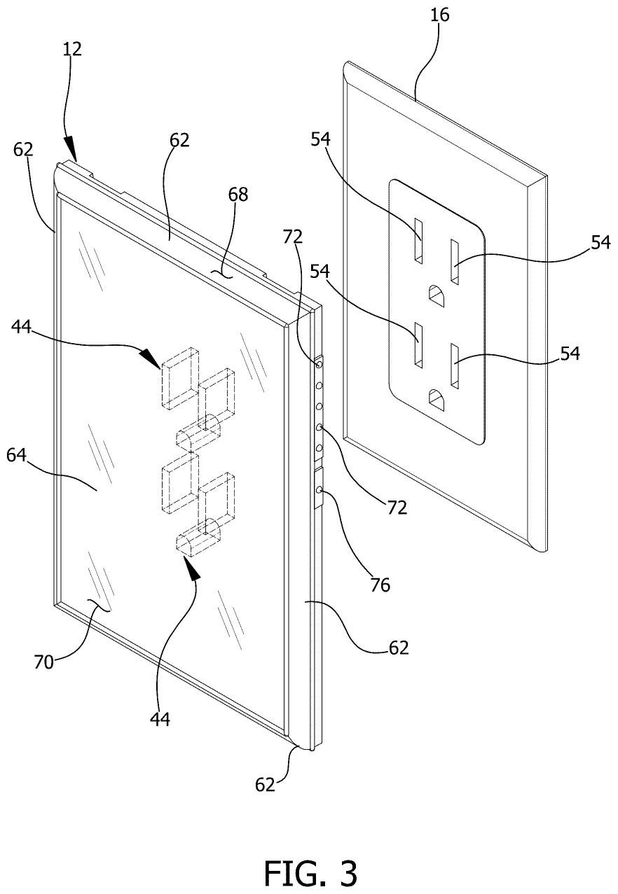

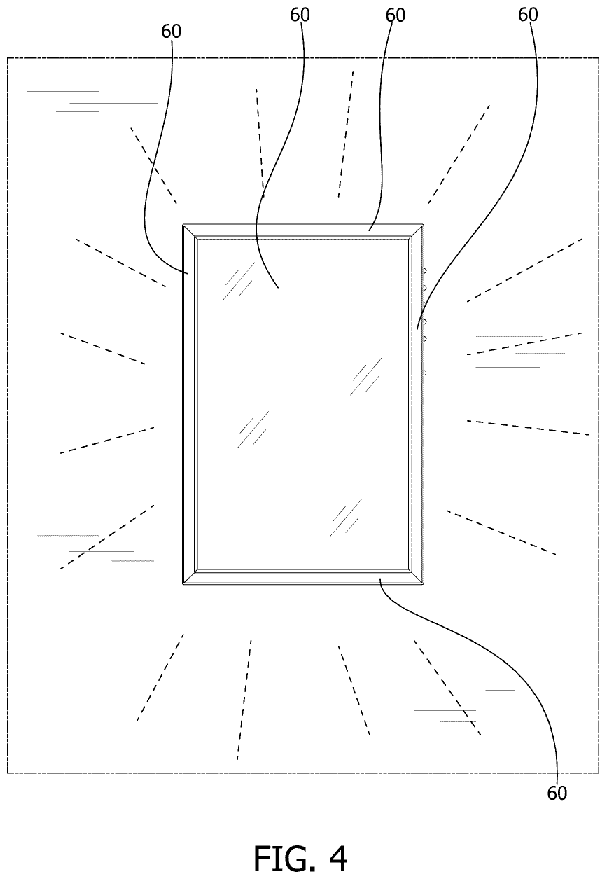

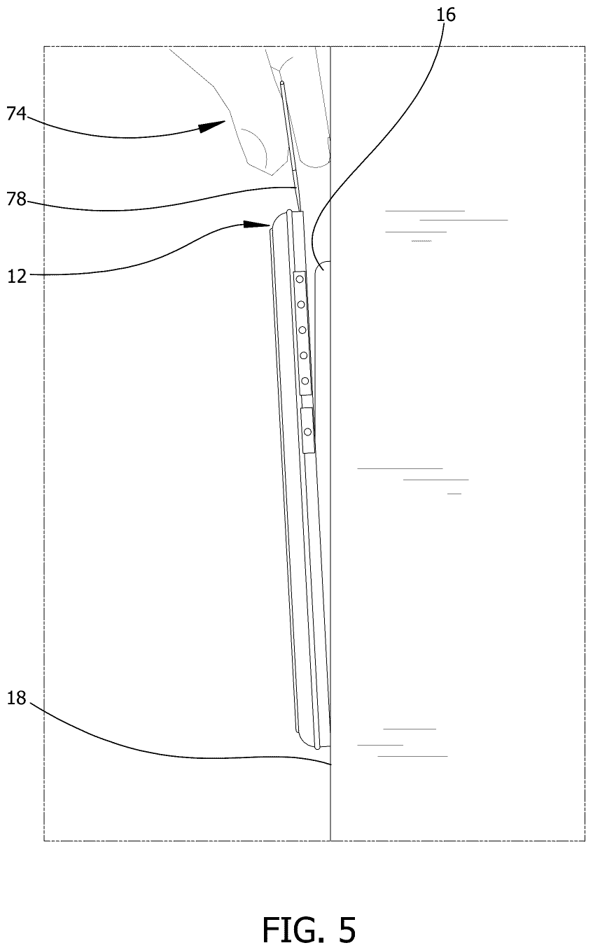

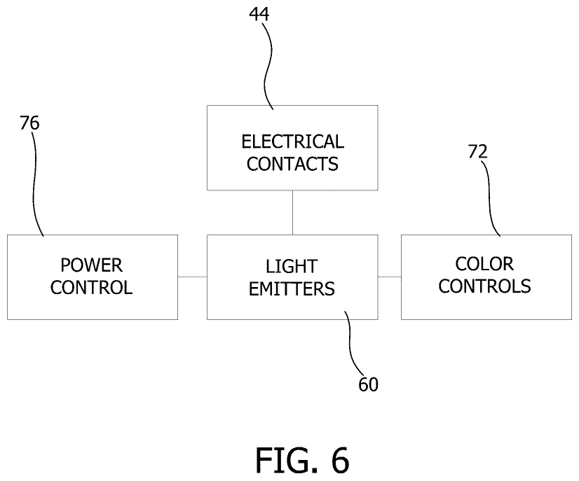

With reference now to the drawings, and in particular to FIGS. 1 through 6 thereof, a new electrical outlet cover device embodying the principles and concepts of an embodiment of the disclosure and generally designated by the reference numeral 10 will be described.

As best illustrated in FIGS. 1 through 6, the illuminated electrical outlet cover device 10 generally comprises a wall plate 12 that has a recess 14 which is integrated into the wall plate 12 thereby enabling the wall plate 12 to be positioned over an electrical outlet 16 in a wall 18. Furthermore, the electrical outlet 16 is positioned in the recess 14 thereby inhibiting children from accessing the electrical outlet 16. The electrical outlet 16 may be a female electrical outlet of any conventional design that is commonly employed in residential construction and which conforms to the National Electrical Code for the United States. The wall plate 12 has a front surface 20 and a rear surface 22 and a perimeter surface 24 extending between the front surface 20 and the rear surface 22; the recess 14 extends into the rear surface 22. The recess 14 has a bounding edge 26 which has a plurality of intersecting sides 28 each spaced from and oriented parallel to a respective one of a plurality of sides 30 of the perimeter surface 24 and the recess 14 has a front bounding surface 32.

The wall plate 12 has a pair of access slots 34 each extending into the rear surface 22 of the wall plate 12 and each of the pair of access slots 34 is aligned with a top side 36 of the perimeter surface 24. Furthermore, each of the pair of access slots 34 has a lower bounding edge 38 which is concavely arcuate with respect to the top side 36 of the perimeter surface 24 such that each of the pair of access slots 34 has a semi-circular shape. Each of the pair of access slots 34 is spaced from a respective one of a first lateral side 40 and a second lateral side 42 of the perimeter surface 24 of the wall plate 12.

A plurality of electrical contacts 44 is each coupled to and extends away from the wall plate 12 thereby enabling each of the plurality of electrical contacts 44 to be electrically mated to the electrical outlet 16 when the wall plate 12 is positioned over the electrical outlet 16. Each of the plurality of electrical contacts 44 extends away from the front bounding surface 32 of the recess 14 in the rear surface 22 of the wall plate 12. Additionally, each of the plurality of electrical contacts 44 is comprised of an electrically conductive material. In this way each of the plurality of electrical contacts 44 to be placed in electrical communication with the electrical outlet 16 when the plurality of electrical contacts 44 are electrically mated to the electrical outlet 16.

The plurality of electrical contacts 44 includes a set of first electrical contacts 46 and a set of second electrical contacts 48. The set of first electrical contacts 46 includes a pair of blade contacts 50 and a rounded contact 52 and each of the pair of blade contacts 50 and the rounded contact 52 are matable to a respective plurality of sockets 54 in the electrical outlet 16. The set of second electrical contacts 48 includes a pair of blade contacts 56 and a rounded contact 58 and each of the pair of blade contacts 56 and the rounded contact 58 of the set of second electrical contacts 48 are matable to a respective plurality of the sockets 54 in the electrical outlet 16.

A plurality of light emitters 60 is provided and each of the plurality of light emitters 60 is attached to the wall plate 12 to emit light outwardly from the wall plate 12 when the plurality of light emitters 60 is turned on. In this way the plurality of light emitters 60 are enabled to illuminate a room in which the electrical outlet 16 is positioned. Each of the plurality of light emitters 60 is in communication with the plurality of electrical contacts 44 such that each of the plurality of light emitters 60 is powered by the electrical outlet 16. Furthermore, each of the plurality of light emitters 60 may comprise a light emitting diode strip or other type of electronic light emitter that can emit light in a variety of colors. In addition, each of the plurality of light emitters 60 emits light of an intensity which is no greater than 200.0 lumens thereby enabling the plurality of light emitters 60 to softly illuminate the room in the convention of a night light.

Each of the plurality of light emitters 60 is positioned on the front surface 20 of the wall plate 12. The plurality of light emitters 60 includes a set of perimeter light emitters 62 and a front light emitter 64. Each of the set of perimeter light emitters 62 is aligned with a respective one of the top side 36 and a bottom side 66 and the first lateral side 40 and the second lateral side 42 of the perimeter surface 24 of the wall plate 12. Additionally, the front light emitter 64 is surrounded by the set of perimeter light emitters 62. Each of the set of perimeter light emitters 62 has an exposed surface 68 which curves inwardly between the perimeter surface 24 of the wall plate 12 and an exposed surface 70 of the front light emitter 64. Furthermore, each of the plurality of light emitters 60 is electrically coupled to the plurality of electrical contacts 44.

A plurality of color controls 72 is provided and each of the plurality of color controls 72 is movably integrated into the perimeter surface 24 of the wall plate 12. In this way each of the plurality of color controls 72 can be manipulated by a user 74. Each of the plurality of color controls 72 is electrically coupled to the plurality of light emitters 60. Each of the plurality of light emitters 60 is actuated to emit a respective color of light which corresponds to a respective one of the plurality of color controls 72 when the respective color control 72 is manipulated. In this way the plurality of color controls 72 can enable to the user 74 to select the color of light which is emitted by the plurality of light emitters 60. A power control 76 is movably integrated into the perimeter surface 24 of the wall plate 12 and the power control 76 can be manipulated by the user 74. The power control 76 is electrically coupled to the plurality of light emitters 60 and each of the plurality of light emitters 60 is turned on or off when the power control 76 is manipulated.

A removal tool 78 is insertable behind the wall plate 12 thereby enabling the removal tool 78 to urge the wall plate 12 into an angled orientation to enable the user 74 to remove the wall plate 12 from the electrical outlet 16. The removal tool 78 has a handle 80 and a wedge 82 which is attached to the handle 80 and the wedge 82 tapers to a point at a lower edge 84 of the wedge 82. The handle 80 has a first member 86 which extends away from an upper edge 88 of the wedge 82 and a second member 90 which is perpendicular to the first member 86 having the second member 90 being spaced from the upper edge 88 of the wedge 82. The lower edge 84 of the wedge 82 is insertable into a respective one of the pair of access slots 34 in the rear surface 22 of the wall plate 12 to enable to user 74 to pull the handle 80 forwardly thereby enabling the user 74 to remove the wall plate 12 from the electrical outlet 16.

In use, the wall plate 12 is positioned over the electrical outlet 16 such that each of the electrical contacts 44 is mated to the electrical outlet 16. In this way the wall plate 12 completely covers the electrical outlet 16 to inhibit children from being able to access the electrical 16 outlet. The power control 76 is manipulated to turn on the plurality of light emitters 60 and a respective color control 72 is manipulated to choose the color of light that is emitted by the plurality of light emitters 60. The wedge 82 of the removal tool 78 is inserted into a respective access slot 34 in the rear surface 22 of the wall plate 12 and the handle 80 is pulled forwardly to enable the electrical contacts 44 to be un-mated from the electrical outlet 16 for removing the wall plate 12 from the electrical outlet 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An illuminated electrical outlet cover device for emitting light while covering an electrical outlet to inhibit children from accessing the electrical outlet, said device comprising:
a wall plate having a recess being integrated into said wall plate wherein said wall plate is configured to be positioned over an electrical outlet in a wall having the electrical outlet being positioned in said recess thereby inhibiting children from accessing the electrical outlet;
a plurality of electrical contacts, each of said plurality of electrical contacts being coupled to and extending away from said wall plate wherein each of said plurality of electrical contacts is configured to be electrically mated to the electrical outlet when said wall plate is positioned over the electrical outlet;
a plurality of light emitters, each of said plurality of light emitters being attached to said wall plate wherein each of said plurality of light emitters is configured to emit light outwardly from said wall plate when said plurality of light emitters is turned on thereby enabling said plurality of light emitters to illuminate a room in which the electrical outlet is positioned, each of said plurality of light emitters being in communication with said plurality of electrical contacts wherein each of said plurality of light emitters is configured to be powered by the electrical outlet; and
a removal tool being insertable behind said wall plate thereby enabling said removal tool to urge said wall plate into an angled orientation wherein said removal tool is configured to enable the user to remove said wall plate from the electrical outlet.

2. The device according to claim 1, wherein:
said wall plate has a front surface and a rear surface and a perimeter surface extending between said front surface and said rear surface;
said recess extends into said rear surface;
said recess has a bounding edge which has a plurality of intersecting sides each being spaced from and oriented parallel to a respective one of a plurality of sides of said perimeter surface;
said wall plate has a pair of access slots each extending into said rear surface of said wall plate;
each of said pair of access slots is aligned with a top side of said perimeter surface;
each of said pair of access slots has a lower bounding edge which is concavely arcuate with respect to said top side of said perimeter surface such that each of said pair of access slots has a semi-circular shape; and
each of said pair of access slots is spaced from a respective one of a first lateral side and a second lateral side of said perimeter surface of said wall plate.

3. The device according to claim 1, wherein:
said recess has a front bounding surface;
each of said plurality of electrical contacts extends away from said front bounding surface of said recess;
each of said plurality of electrical contacts is comprised of an electrically conductive material wherein each of said plurality of electrical contacts is configured to be placed in electrical communication with the electrical outlet when said plurality of electrical contacts are electrically mated to the electrical outlet;
said plurality of electrical contacts includes a set of first electrical contacts and a set of second electrical contacts;
said set of first electrical contacts includes a pair of blade contacts and a rounded contact wherein each of said pair of blade contacts and said rounded contact are configured to be matable to a respective plurality of sockets in the electrical outlet; and
said set of second electrical contacts includes a pair of blade contacts and a rounded contact wherein each of said pair of blade contacts and said rounded contact of said set of second electrical contacts are configured to be matable to a respective plurality of sockets in the electrical outlet.

4. The device according to claim 2, wherein:
each of said plurality of light emitters is positioned on said front surface of said wall plate;
said plurality of light emitters includes a set of perimeter light emitters and a front light emitter;
each of said set of perimeter light emitters is aligned with a respective one of said top side and a bottom side and said first lateral side and said second lateral side of said perimeter surface of said wall plate;
said front light emitter is surrounded by said set of perimeter light emitters;
each of said set of perimeter light emitters has an exposed surface which curves inwardly between said perimeter surface of said wall plate and an exposed surface of said front light emitter; and
each of said plurality of light emitters is electrically coupled to said plurality of electrical contacts.

5. The device according to claim 1, wherein:
said device includes a plurality of color controls;
each of said plurality of color controls being movably integrated into a perimeter surface of said wall plate wherein each of said plurality of color controls is configured to be manipulated by a user;
each of said plurality of color controls is electrically coupled to said plurality of light emitters; and
each of said plurality of light emitters is actuated to emit a respective color of light which corresponds to a respective one of said plurality of color controls when said respective color control is manipulated wherein said plurality of color controls is configured to enable to the user to select the color of light which is emitted by said plurality of light emitters.

6. The device according to claim 1, wherein:
said device includes a power control being movably integrated into a perimeter surface of said wall plate wherein said power control is configured to be manipulated by the user;
said power control is electrically coupled to said plurality of light emitters; and
each of said plurality of light emitters is turned on or off when said power control is manipulated.

7. The device according to claim 2, wherein:
said removal tool has a handle and a wedge being attached to said handle;
said wedge tapers to a point at a lower edge of said wedge;
said handle has a first member which extends away from an upper edge of said wedge and a second member which is perpendicular to said first member having said second member being spaced from said upper edge of said wedge; and
said lower edge of said wedge is insertable into a respective one of said pair of access slots in said rear surface of said wall plate wherein said second member of said handle is configured to enable to user to pull said handle forwardly thereby enabling the user to remove said wall plate from the electrical outlet.

8. An illuminated electrical outlet cover device for emitting light while covering an electrical outlet to inhibit children from accessing the electrical outlet, said device comprising:
a wall plate having a recess being integrated into said wall plate wherein said wall plate is configured to be positioned over an electrical outlet in a wall having the electrical outlet being positioned in said recess thereby inhibiting children from accessing the electrical outlet, said wall plate having a front surface and a rear surface and a perimeter surface extending between said front surface and said rear surface, said recess extending into said rear surface, said recess having a bounding edge which has a plurality of intersecting sides each being spaced from and oriented parallel to a respective one of a plurality of sides of said perimeter surface, said recess having a front bounding surface, said wall plate having a pair of access slots each extending into said rear surface of said wall plate, each of said pair of access slots being aligned with a top side of said perimeter surface, each of said pair of access slots having a lower bounding edge which is concavely arcuate with respect to said top side of said perimeter surface such that each of said pair of access slots has a semi-circular shape, each of said pair of access slots being spaced from a respective one of a first lateral side and a second lateral side of said perimeter surface of said wall plate;
a plurality of electrical contacts, each of said plurality of electrical contacts being coupled to and extending away from said wall plate wherein each of said plurality of electrical contacts is configured to be electrically mated to the electrical outlet when said wall plate is positioned over the electrical outlet, each of said plurality of electrical contacts extending away from said front bounding surface of said recess in said rear surface of said wall plate, each of said plurality of electrical contacts being comprised of an electrically conductive material wherein each of said plurality of electrical contacts is configured to be placed in electrical communication with the electrical outlet when said plurality of electrical contacts are electrically mated to the electrical outlet, said plurality of electrical contacts including a set of first electrical contacts and a set of second electrical contacts, said set of first electrical contacts including a pair of blade contacts and a rounded contact wherein each of said pair of blade contacts and said rounded contact are configured to be matable to a respective plurality of sockets in the electrical outlet, said set of second electrical contacts including a pair of blade contacts and a rounded contact wherein each of said pair of blade contacts and said rounded contact of said set of second electrical contacts are configured to be matable to a respective plurality of sockets in the electrical outlet;
a plurality of light emitters, each of said plurality of light emitters being attached to said wall plate wherein each of said plurality of light emitters is configured to emit light outwardly from said wall plate when said plurality of light emitters is turned on thereby enabling said plurality of light emitters to illuminate a room in which the electrical outlet is positioned, each of said plurality of light emitters being in communication with said plurality of electrical contacts wherein each of said plurality of light emitters is configured to be powered by the electrical outlet, each of said plurality of light emitters being positioned on said front surface of said wall plate, said plurality of light emitters including a set of perimeter light emitters and a front light emitter, each of said set of perimeter light emitters being aligned with a respective one of said top side and a bottom side and said first lateral side and said second lateral side of said perimeter surface of said wall plate, said front light emitter being surrounded by said set of perimeter light emitters, each of said set of perimeter light emitters having an exposed surface which curves inwardly between said perimeter surface of said wall plate and an exposed surface of said front light emitter, each of said plurality of light emitters being electrically coupled to said plurality of electrical contacts;
a plurality of color controls, each of said plurality of color controls being movably integrated into said perimeter surface of said wall plate wherein each of said plurality of color controls is configured to be manipulated by a user, each of said plurality of color controls being electrically coupled to said plurality of light emitters, each of said plurality of light emitters being actuated to emit a respective color of light which corresponds to a respective one of said plurality of color controls when said respective color control is manipulated wherein said plurality of color controls is configured to enable to the user to select the color of light which is emitted by said plurality of light emitters;
a power control being movably integrated into said perimeter surface of said wall plate wherein said power control is configured to be manipulated by the user, said power control being electrically coupled to said plurality of light emitters, each of said plurality of light emitters being turned on or off when said power control is manipulated; and
a removal tool being insertable behind said wall plate thereby enabling said removal tool to urge said wall plate into an angled orientation wherein said removal tool is configured to enable the user to remove said wall plate from the electrical outlet, said removal tool having a handle and a wedge being attached to said handle, said wedge tapering to a point at a lower edge of said wedge, said handle having a first member which extends away from an upper edge of said wedge and a second member which is perpendicular to said first member having said second member being spaced from said upper edge of said wedge, said lower edge of said wedge being insertable into a respective one of said pair of access slots in said rear surface of said wall plate wherein said second member of said handle is configured to enable to user to pull said handle forwardly thereby enabling the user to remove said wall plate from the electrical outlet.
